(19) United States
(12) Patent Application Publication
(10) Pub. No.: US 2022/0180148 A1
(43) Pub. Date: Jun. 9, 2022

(54) INFORMATION PROCESSING DEVICE, INFORMATION PROCESSING METHOD, AND RECORDING MEDIUM

(71) Applicants: NEC Corporation, Tokyo (JP); NATIONAL INSTITUTE OF ADVANCED INDUSTRIAL SCIENCE AND TECHNOLOGY, Tokyo (JP)

(72) Inventors: Shumpei KUBOSAWA, Tokyo (JP); Takashi ONISHI, Tokyo (JP); Yoshimasa TSURUOKA, Tokyo (JP)

(73) Assignees: NEC Corporation, Tokyo (JP); NATIONAL INSTITUTE OF ADVANCED INDUSTRIAL SCIENCE AND TECHNOLOGY, Tokyo (JP)

(21) Appl. No.: 17/442,347

(22) PCT Filed: Mar. 23, 2020
(86) PCT No.: PCT/JP2020/012679

§ 371 Date: Sep. 23, 2021

(30) Foreign Application Priority Data
Mar. 28, 2019 (JP) 2019-064977

(51) Int. Cl. G06N 3/04; G06N 3/08

(52) U.S. Cl. CPC G06N 3/04; G06N 3/08

(57) ABSTRACT

An information processing device includes: a plurality of linear combination nodes that linearly combine input values; a selection node that is provided to the linear combination node and calculates, according to the input values, a value indicating whether or not a corresponding linear combination node is selected; and an output node that outputs an output value calculated based on a value of the linear combination node and a value of the selection node.

### TECHNICAL FIELD

The present invention relates to an information processing device, an information processing method, and a recording medium.

### BACKGROUND ART

Non-linear activation functions are sometimes used to perform more complex processing using a feedforward neural network.

For example, in order to achieve both a shorter prediction time and generalization performance, the neural network described in Patent Document 1 includes, in a hidden layer, a plurality of COS elements using a cosine (COS) function as an activation function, and a E element that obtains a weighted total of the outputs of the plurality of COS elements.

### PRIOR ART DOCUMENTS

### Patent Document

[Patent Document 1] Japanese Unexamined Patent Application, First Publication No. 2016-218513

### SUMMARY OF THE INVENTION

### Problem to be Solved by the Invention

A feedforward neural network handling a non-linear model using a non-linear activation function can perform more complicated processing than that in case of handling only a linear model. On the other hand, by using a non-linear activation function in a feedforward neural network, the expressed model becomes complicated, and it becomes difficult to interpret the processing.

An example object of the present invention is to provide an information processing device, an information processing method, and a recording medium that are capable of solving the above problem.

### Means for Solving the Problem

According to a first example aspect of the present invention, an information processing device includes: a plurality of linear combination nodes that linearly combine input values; a selection node that is provided to the linear combination node and calculates, according to the input values, a value indicating whether or not a corresponding linear combination node is selected; and an output node that outputs an output value calculated based on a value of the linear combination node and a value of the selection node.an information processing device includes: a plurality of linear combination nodes which linearly combine input values; a selection node which is provided to the linear combination node and which calculates, according to the input value, a value indicating whether or not a corresponding linear combination node is selected; and an output node which outputs an output value calculated based on the value of the linear combination node and the value of the selection node.

According to a second example aspect of the present invention, an information processing method is executed by a computer, and includes: calculating a plurality of linear combination node values in which input values are linearly combined; calculating, with respect to the linear combination node value, a selection node value indicating whether or not the linear combination node value is selected; and calculating an output value based on the linear combination node value and the selection node value.

According to a third example aspect of the present invention, a recording medium stores a program that causes a computer to execute: a function of calculating a plurality of linear combination node values in which input values are linearly combined; a function of calculating, with respect to the linear combination node value, a selection node value indicating whether or not the linear combination node value is selected; and a function of calculating an output value based on the linear combination node value and the selection node value.

### Effect of the Invention

According to an example embodiment of the present invention, a non-linear model can be expressed, and the interpretability of the model is relatively high.

### BRIEF DESCRIPTION OF THE DRAWINGS

FIG. 1 is a schematic block diagram showing an example of a functional configuration of an information processing device according to an example embodiment.

FIG. 2 is a diagram showing an example of a network showing the processing performed by the information processing device according to the example embodiment.

FIG. 3 is a diagram showing an example of selection of a linear combination node in a piecewise linear network according to the example embodiment.

FIG. 4 is a diagram showing an example of a piecewise linear network in which the number of hidden layer nodes according to the example embodiment is variable.

FIG. 5 is a diagram showing an example of a chemical plant to which the piecewise linear network according to the example embodiment is applied.

FIG. 6 is a diagram showing an example of a configuration of the information processing device according to the example embodiment.

FIG. 7 is a diagram showing an example of the processing of an information processing method according to the example embodiment.

FIG. 8 is a schematic block diagram showing a configuration of a computer according to at least one example embodiment.

### EXAMPLE EMBODIMENT

Hereunder, example embodiments of the present embodiment will be described. However, the following example embodiments do not limit the invention according to the claims. Furthermore, all combinations of features described in the example embodiments may not be essential to the solution means of the invention.

<Configuration of Information Processing Device>

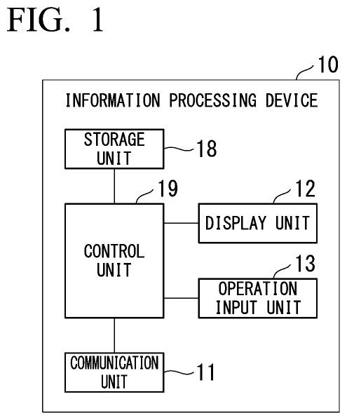

FIG. 1 is a schematic block diagram showing an example of a functional configuration of an information processing device 10 according to an example embodiment. In the configuration shown in FIG. 1, the information processing device 10 includes a communication unit 11, a display unit 12, an operation input unit 13, a storage unit 18, and a control unit 19.

The information processing device 10 calculates output data based on input data. In particular, the information processing device 10 applies input data to a piecewise linear model using a piecewise linear network described below to calculate output data.

The communication unit 11 performs communication with other devices. The communication unit 11 may receive input data from another device. Furthermore, the communication unit 11 may transmit the calculation results (output data) of the information processing device 10 to another device.

The display unit 12 and the operation input unit 13 constitute a user interface of the information processing device 10.

The display unit 12 includes, for example, a display screen such as a liquid crystal panel or an LED (Light Emitting Diode), and displays various images. For example, the display unit 12 may display the calculation results of the information processing device 10.

The operation input unit 13 includes input devices such as a keyboard and a mouse, and accepts user operations. For example, the operation input unit 13 may accept a user operation that sets a parameter value for the information processing device 10 to perform machine learning.

The storage unit 18 stores various data. The storage unit 18 is configured by using a storage device included in the information processing device 10.

The control unit 19 performs various processing that controls each unit of the information processing device 10. The functions of the control unit 19 are executed as a result of a CPU (Central Processing Unit) included in the information processing device 10 reading and executing a program from the storage unit 18.

<Configuration of Piecewise Linear Network>

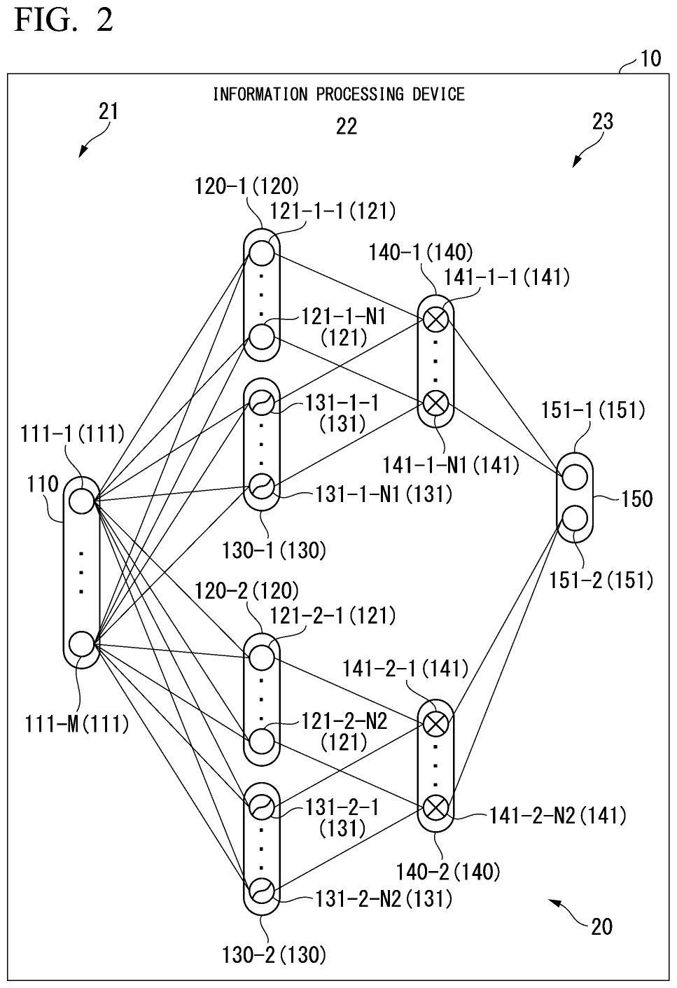

FIG. 2 is a diagram showing an example of a network showing the processing performed by the information processing device 10. Hereunder, the network representing the processing performed by the information processing device 10 is referred to as a piecewise linear (PL) network. A piecewise linear network constructs a piecewise linear model using a linear model as a sub-model. The linear model is, for example, a multiple regression equation in which each dimension of the input data is an explanatory variable, a multiple regression equation in which the logarithm of each dimension of the input data is an explanatory variable, or a multiple regression equation in which each dimension of data obtained by applying one or more multivariable non-linear functions to the input data is used as an explanatory variable. However, the linear model is not limited to the examples described above.

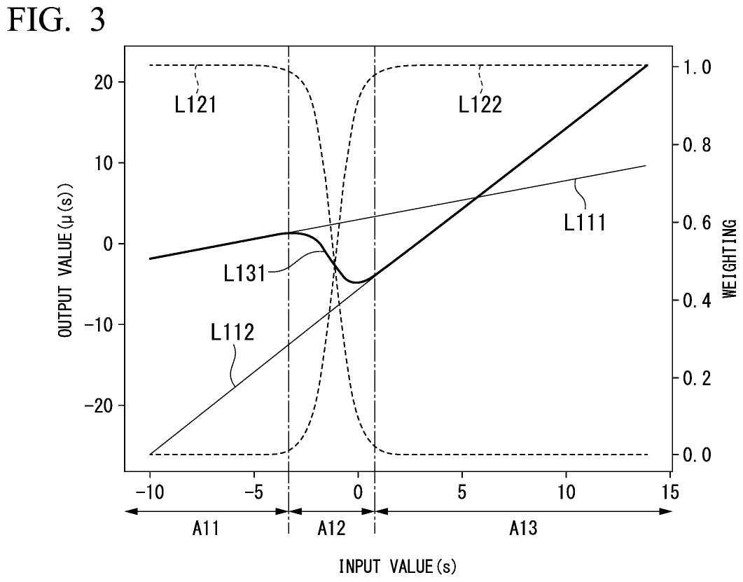

In a piecewise linear network, for example, a numerical interval as shown by the horizontal axis in FIG. 3 is not necessarily divided into a plurality of intervals. As a result of the information processing device 10 performing the processing described as the operation of the piecewise linear network (specifically, by executing the processing of each unit, such as the linear node vector, the selection node vector, and the element unit product node vector described below), processing that divides the numerical interval into a plurality of intervals as illustrated in FIG. 3 is executed. Alternatively, it can be said that the information processing device 10 sets the intervals illustrated in FIG. 3 by setting each unit of the piecewise linear network by machine learning.

In the example of FIG. 2, the piecewise linear network 20 includes an input layer 21, an intermediate layer (hidden layer) 22, and an output layer 23.

For example, the information processing device 10 stores a program of the piecewise linear network 20 in the storage unit 18, and the control unit 19 reads and executes the program to execute the processing of the piecewise linear network 20.

However, the method of executing the processing of the piecewise linear network 20 is not limited to this. For example, the information processing device 10 may execute the processing of the piecewise linear network 20 by hardware, such as by configuring the piecewise linear network 20 using an ASIC (Application Specific Integrated Circuit).

The input layer 21 includes an input node vector 110. The number of elements in the input node vector is M (where M is a positive integer). The elements of the input node vector 110 are referred to as input nodes 111-1 to 111-M. The input nodes 111-1 to 111-M are collectively referred to as input nodes 111.

Each of the input nodes 111 accepts a data input to the piecewise linear network 20. Therefore, the input node vector 110 acquires an input vector value to the piecewise linear network 20, and outputs it to the nodes of the intermediate layer 22.

The number M of input nodes 111 is not limited to a specific number, and may be one or more.

The intermediate layer 22 includes linear combination node vectors 120-1 and 120-2, selection node vectors 130-1 and 130-2, and element unit product node vectors 140-1 and 140-2.

The linear combination node vectors 120-1 and 120-2 are collectively referred to as linear combination node vectors 120. The selection node vectors 130-1 and 130-2 are collectively referred to as selection node vectors 130. The element unit product node vectors 140-1 and 140-2 are collectively referred to as element unit product node vectors 140.

However, the number of linear combination node vectors 120, selection node vectors 130, and element unit product node vectors 140 included in the piecewise linear network 20 is not limited to two as shown in FIG. 2. The piecewise linear network 20 includes the same number of linear combination node vectors 120, selection node vectors 130, and element unit product node vectors 140.

When the number of elements in the linear combination node vector 120-1 is N1 (where N1 is a positive integer), the elements of the linear combination node vector 120-1 are referred to as linear combination nodes 121-1-1 to 121-1-N1. When the number of elements in the linear combination node vector 120-2 is N2 (where N2 is a positive integer), the elements of the linear combination node vector 120-2 are referred to as linear combination nodes 121-2-1 to 121-2-N2.

The linear combination nodes 121-1-1 to 121-1-N1 and 121-2-1 to 121-2-N2 are collectively referred to as linear combination nodes 121.

Each of the linear combination nodes 121 linearly combines the values of the input node vector 110 (input vector values to the piecewise linear network 20). The calculation performed by the linear combination nodes 121 is represented by equation (1).

$$\begin{matrix}[ Equation 1 ] & \\ {f}_{i} ( x ) = {\sum }_{j} {w}_{j , i} {x}_{j} + {b}_{i} & ( 1 )\end{matrix}$$

Here, “x” on the left side of equation (1) represents the values of the input node vector 110. When the number of input nodes 111 is M (where M is a positive integer), this is written as x=[x₁, . . . , x_{M}].

Also, “xⱼ” on the right side of equation (1) represents the value of the jth element of the input node vector 110. “w_{j,i}” represents a weighting coefficient which is multiplied with the jth element of the input node vector 110 when the linear combination node 121, which is the ith element of the linear combination node vector 120, calculates the value of the linear combination node 121 itself. “bᵢ” represents a bias value set for each linear combination node. The weighting coefficient w_{j,i} and the bias value bᵢ are each set or updated by machine learning.

The number of elements in the selection node vector 130-1 is N1, which is the same as the number of elements in the linear combination node vector 120-1. The elements of the selection node vector 130-1 are referred to as selection nodes 131-1-1 to 131-1-N1. The number of elements in the selection node vector 130-2 is N2, which is the same as the number of elements in the linear combination node vector 120-2. The elements of the selection node vector 130-2 are referred to as selection nodes 131-2-1 to 131-2-N2.

The selection nodes 131-1-1 to 131-1-N1 and 131-2-1 to 131-2-N2 are collectively referred to as selection nodes 131.

The selection nodes 131 calculate a value based on the values of the input node vector 110, and apply the calculated value to an activation function. The output value of a selection node 131 determines whether or not to select the linear combination node 121 which is associated one-to-one with the selection node 131.

As the method used by the selection nodes 131 to calculate a value based on the values of the input node vector 110, various methods can be used in which the basis of selecting the linear combination nodes 121 is easily understood, and is trainable (by machine learning) using a gradient method (back propagation).

For example, the selection nodes 131 may linearly combine the values of the input node vector 110 as in the case of the linear combination nodes 121. Alternatively, the selection nodes 131 may divide the input space into two in each axial direction, and select a region in the input space by using a decision tree which is trainable by the back propagation method.

The linear combination nodes 121 and the selection nodes 131 have a common feature in that they calculate a value based on the values of the input node vector 110. On the other hand, the linear combination nodes 121 and the selection nodes 131 differ in that the linear combination nodes 121 use a linear combination of the values of the input node vector 110 calculated in equation (1) as the node value (output from the node), while the selection nodes 131 apply a value based on the values of the input node vector 110 to the activation function. As a result of applying a value based on the values of the input node vector 110 to the activation function, the value of any one element of the selection node vector 130 preferably approaches 1, and the values of the other elements approach 0.

The selection nodes 131 are nodes that calculate a value for indicating whether or not the linear combination nodes 121 are selected, and the linear combination nodes 121 and the selection nodes 131 are associated one-to-one with each other. Of the linear combination nodes 121 included in the linear combination node vector 120, the linear combination node 121 associated with the selection node 131 whose value is close to 1 becomes dominant in the output value of the piecewise linear network 20. In this respect, of the linear combination nodes 121 included in the linear combination node vector 120, the linear combination node 121 associated with the selection node 131 whose value is close to 1 is selected.

A Softmax function can be used as the activation function used by the selection nodes 131. The Softmax function is represented by equation (2).

$$\begin{matrix}[ Equation 2 ] & \\ {σ}_{i} ( x ) = \frac{{e}^{{x}_{i}}}{{\sum }_{j} {e}^{{x}_{j}}} & ( 2 )\end{matrix}$$

When the Softmax function in equation (2) is used as the activation function of the selection nodes 131, unlike the case of equation (1), “x” on the left side of equation (2) represents a vector of linearly combined values of the input node vector 110. Using the notation in equation (1), “x=[f₁(x), . . . , f_{N}(x)]” (where N=N1 or N=N2).

The linear combination nodes 121 and the selection nodes 131 are each provided with a weighting coefficient w_{j,i} and a bias value bᵢ. Therefore, even when the linear combination nodes 121 and the selection nodes 131 are associated with each other, the values of the weighting coefficient w_{j,i} and values of the bias value bᵢ are usually different values.

Here, “σᵢ(x)” represents the value of the ith element of the selection node vector 130.

Also, “xⱼ” on the right side of equation (2) represents an element of x. Using the notation in equation (1), xⱼ=f(xⱼ). “e” represents Napier's constant.

As shown in equation (2), in the calculation of the values of the selection node vector 130, each of the selection nodes 131, which are the elements of the selection node vector 130, calculates the value of e^{xi} for each element (that is to say, for each selection node 131). Then, by dividing the calculated value by the sum of the e^{xi} values of the entire selection node vector 130 (specifically, the entire selection node vector 130-1 and the entire selection node vector 130-2), the value is normalized to a value of 0 or more and 1 or less. The value of σᵢ(x) calculated in equation (2) takes a value of 0 or more and 1 or less. Further, the sum of the σᵢ(x) values of the entire selection node vector 130 is 1. In this way, σᵢ(x) has probability-like properties.

However, the activation function used by the selection nodes 131 is not limited to a Softmax function. As the activation function used by the selection nodes 131, various values that can select a specific node can be used. For example, as the activation function used by the selection nodes 131, a step function (single edge function) in which the value of any one selection node 131 is 1, and the values of the other selection nodes 131 are all 0, may be used.

The number of elements in the element unit product node vector 140-1 is N1, which is the same as the number of elements in the linear combination node vector 120-1. The elements of the element unit product node vector 140-1 are referred to as element unit product nodes 141-1-1 to 141-1-N1. The number of elements in the element unit product node vector 140-2 is N2, which is the same as the number of elements in the linear combination node vector 120-2. The elements of the element unit product node vector 140-2 are referred to as element unit product nodes 141-2-1 to 141-2-N2.

The element unit product nodes 141-1-1 to 141-1-N1 and 141-2-1 to 141-2-N2 are collectively referred to as element unit product nodes 141.

The calculation performed by the element unit product nodes 141 is represented by equation (3).

$$\begin{matrix}[ Equation 3 ] & \\ {g}_{i} ( x ) = {f}_{i} ( x ) \cdot {σ}_{i} ( x ) & ( 3 )\end{matrix}$$

Here, gᵢ(x) represents the value of the ith element of the element unit product node vector 140. fᵢ(x) represents the value of the ith element of the linear combination node vector 120. σᵢ(x) represents the value of the ith element of the selection node vector 130.

The element unit product node 141 executes the selection of the linear combination nodes based on the values of the selection nodes 131.

As shown in FIG. 2, as a result of the output from a single linear combination node 121 and the output from a single selection node 131 being input to a single unit element product node, the linear combination nodes 121 and the selection nodes 131 are associated one-to-one with each other. Further, as a result of the element unit product node 141 multiplying the output from the linear combination node 121 and the output from the selection node 131, then when the value of the selection node 131 is close to 0, the value of the associated linear combination node 121 is masked. As a result of the mask, the linear combination node 121 associated with the selection node 131 whose value is close to 1 becomes dominant with respect to the values of the output nodes 151.

In this way, when the value of any one of the elements of the selection node vector 130 approaches 1, and the value of the other elements approaches 0, the linear combination node 121 associated with the element whose value is close to 1 (that is to say, the selection node 131 whose value is close to 1) is selected.

The output layer 23 includes an output node vector 150. In the example of FIG. 2, the output node vector 150 contains two elements. These two elements are referred to as output nodes 151-1 and 151-2.

The output nodes 151-1 and 151-2 are collectively referred to as output nodes 151.

However, the number of elements in the output node vector 150 (the number of output nodes 151) is not limited to two as shown in FIG. 2. As shown in FIG. 2, the output nodes 151 are associated one-to-one with the element unit product node vectors 140. Therefore, the number of output nodes 151 is the same as the number of element unit product node vectors 140.

The calculation performed by the output nodes 151 is represented by equation (4).

$$\begin{matrix}[ Equation 4 ] & \\ {μ}_{k} ( x ) = {\sum }_{i} {g}_{i} ( x ) & ( 4 )\end{matrix}$$

Here, μₖ(x) represents the value of the output node 151 which is the kth element of the output node vector 150. gᵢ(x) represents the value of the element unit product node 141 which is the ith element of the element unit product node vector 140.

As shown in equation (4), the output nodes 151 calculate the sum of the values of all of the elements of a single element unit product node vector 140.

The piecewise linear network 20 can be regarded as a type of feedforward neural network in that it has an input layer, an intermediate layer, and an output layer, and each layer has nodes. On the other hand, the piecewise linear network 20 is different from a typical feedforward neural network in that it includes the linear combination nodes 121, the selection nodes 131, and the element unit product nodes 141.

### <Selection of Sub-Model>

FIG. 3 is a diagram showing an example of selection of a linear combination node in the piecewise linear network 20. The horizontal axis of the graph in FIG. 3 represents the input value. The vertical axis represents the output value of the node. Specifically, the scale on the right side of the graph in FIG. 3 is a scale representing the value of the selection node 131. Here, the value of the selection node 131 is also referred to as a weighting. Furthermore, the scale on the left side of the graph in FIG. 3 is a scale representing the value of the linear combination node 121 and the value of the output node 151.

FIG. 3 shows a case where the number of elements in the linear combination node vector 120 is two. These elements are referred to as a first linear combination node 121-1 and a second linear combination node 121-2. Moreover, the selection node associated with the first linear combination node 121-1 is referred to as a first selection node 131-1. The selection node associated with the second linear combination node 121-2 is referred to as a second selection node 131-2.

The line L111 represents the value of the first linear combination node 121-1. The line L112 represents the value of the second linear combination node 121-2.

The line L121 represents the value of the first selection node 131-1. The line L122 represents the value of the second selection node 131-2.

The line L131 represents the value of the output node 151.

When the range of −10 to (+)15 over which input values can be taken is divided into three regions, namely the regions A11, A12, and A13, then in the region A11, the value of the first linear combination node 121-1 (see line L111) is close to 1, and the value of the second linear combination node 121-2 (see line L112) is close to 0. Therefore, the value of the first linear combination node 121-1 (see line L111) is dominant in the value of the output node 151 (see line L131).

In the region A13, the value of the second linear combination node 121-2 (see line L112) is close to 1, and the value of the first linear combination node 121-1 (see line L111) is close to 0. Therefore, the value of the second linear combination node 121-2 (see line L112) is dominant in the value of the output node 151 (see line L131).

On the other hand, in the region A12, a weighted average of the value of the first linear combination node 121-1 (see line L111) and the value of the second linear combination node 121-2 (see line L112) is taken using the value of the first selection node 131-1 (see line L121) and the value of the second selection node 131-2 (see line L122) as the respective weightings, and the calculation result becomes the value of the output node 151 (see line L131).

In the piecewise linear network 20, by selecting one of the linear combination nodes 121 according to the input value in the regions A11 and A13, a piecewise linear model is formed using the linear models formed by the linear combination nodes 121 as sub-models.

Because the piecewise linear network 20 forms a piecewise linear model, the model can be interpreted relatively easily.

### (Expression Capability of Piecewise Linear Network)

The piecewise linear network 20 is capable of expressing the same piecewise linear functions as in the case of a rectified linear unit (ReLU) neural network (as an asymptotic approximation in the limit). The rectified linear unit neural network referred to here is a neural network that uses a rectified linear unit function (also referred to as a ramp function) as the activation function. The rectified linear unit function referred to here is represented by equation (5).

$$\begin{matrix}[ Equation 5 ] & \\ f ( x ) = {\sum }_{h} {s}_{h} max ( 0 , {w}_{h}^{T} x + {b}_{h} ) + {t}_{h} & ( 5 )\end{matrix}$$

Here, sₕ is a coefficient, wₕ^{T} is a weighting, and bₕ and tₕ are bias values, all of which are set by machine learning. Further, x is a vector representing the input values. The superscript T indicates the transpose of the matrix or vector. In addition, max(0, wₕ^{T}x+bₕ) is a function that outputs the larger value of 0 and wₕ^{T}x+bₕ.

In the rectified linear unit neural network, a piecewise linear model is generated by synthesizing (superposing) sub-models that are piecewise linear models.

For example, it is possible to express the same piecewise linear functions as in the case of a rectified linear unit neural network (as an asymptotic approximation in the limit) using the piecewise linear network 20 as follows.

(1) Prepare a piecewise linear network 20 in which the number of sub-models is the number of inflection points in the rectified linear unit neural network+1.

(2) The selection model is configured so that the x-coordinates of the inflection points of the rectified linear unit neural network and the selection model inflection points of the piecewise linear network 20 are the same. The selection model referred to here is a model capable of selecting a linear combination node 121 as described above according to the values of the selection nodes 131.

(3) Make the slope of the selection model close to ∞ without changing the inflection points of the selection model of the piecewise linear network 20. In this respect, the model is an asymptotic approximation expression in the limit.

(4) Make the weighting of each sub-model of the piecewise linear network 20 the same as that of each piecewise linear portion of the rectified linear unit neural network.

In addition, the piecewise linear network 20 has a higher model expression capability than the rectified linear unit neural network in the following respects. (a) The piecewise linear network 20 has a larger number of parameters than the rectified linear unit neural network expressing the equivalent functions because sub-models (linear combination nodes 121) are selected. (b) In the piecewise linear network 20, by selecting sub-models (linear combination nodes 121) using the Softmax function described above, the boundaries of the sub-models become curves instead of points.

Here, comparing the model interpretability between the case of the piecewise linear network 20 and the case of the rectified linear unit neural network, it is difficult to interpret which regression equation is used in which input interval in the rectified linear unit neural network.

Specifically, in equation (5) above, it is difficult to interpret what type of the regression equation (sub-model) a specific linear interval constituting the model is, and to interpret which input interval corresponds to the regression equation.

For example, a case will be described in which, in order to interpret the model of the rectified linear unit neural network: (i) a subset Xₕ⊆R^{d} (where Rd represents a d-dimensional real number vector) of an input space x is found that satisfies each equation (6); and (ii) equation (7), which represents a sum over all i satisfying each equation (6) for a certain value of Xₕ, is interpreted as a regression equation (it is found that equation (7) is a regression equation).

Here, equation (6) and equation (7) are as follows.

$$\begin{matrix}[ Equation 6 ] & \\ {w}_{i}^{T} x + {b}_{i} > 0 {X}_{h} ⊆ {ℝ}^{d} & ( 6 ) \\ [ Equation 7 ] & \\ {( {s}_{i} {w}_{i} + {s}_{j} {w}_{j} + ⋯ )}^{T} x + ( {b}_{i} + {t}_{i} ) + ( {b}_{j} + {t}_{j} ) + ⋯ & ( 7 )\end{matrix}$$

In this case, if the model has a large number of dimensions, it is difficult to analyze and interpret either of (i) and (ii) above.

On the other hand, in the piecewise linear network 20, the sub-models are represented by a linear model as in equation (1) above. Further, the sub-models can be interpreted by interpreting the weightings (w_{j,i} in equation (1)) and the bias values (bᵢ in equation (1)).

Moreover, in the piecewise linear network 20, it is possible to determine which sub-models have been selected by inspection of the values of the selection nodes 131.

In this way, according to the piecewise linear network 20, the model can be interpreted relatively easily.

### (Classification Probability in Piecewise Linear Network)

Equation (8) holds for the classification probability of the piecewise linear network 20.

$$\begin{matrix}[ Equation 8 ] & \\ {max}_{c} P ( c \vert {x}_{i} ) \leq 1 & ( 8 )\end{matrix}$$

Here, xᵢ represents the data to be classified. c represents a class.

When the sub-models are selected with certainty for the data xᵢ (it becomes classified into a certain class), the equation (9) holds.

$$\begin{matrix}[ Equation 9 ] & \\ {max}_{c} P ( c \vert {x}_{i} ) = 1 & ( 9 )\end{matrix}$$

From equation (8), equation (10) holds for D pieces of data {xᵢ}ᵢ₌₁^{D}.

$$\begin{matrix}[ Equation 10 ] & \\ {\sum }_{i = 1}^{D} {max}_{c} P ( c \vert {x}_{i} ) \leq D & ( 10 )\end{matrix}$$

Furthermore, assuming that the number of classes is C, equation (11) holds.

$$\begin{matrix}[ Equation 11 ] & \\ \frac{1}{C} \leq {max}_{c} P ( c \vert {x}_{i} ) & ( 11 )\end{matrix}$$

To further explain why equation (11) holds, equation (12) holds when the sub-models are selected in a completely random fashion for the data xᵢ (it becomes classified into a certain class).

$$\begin{matrix}[ Equation 12 ] & \\ \frac{1}{C} = {max}_{c} P ( c \vert {x}_{i} ) & ( 12 )\end{matrix}$$

That is to say, equation (12) holds in the case of “∀c,P(c|xᵢ)=1/C”.

On the other hand, equation (13) holds because “1=Σᵢ₌₁^{D}P(c|xᵢ)”.

$$\begin{matrix}[ Equation 13 ] & \\ ∃ {c}_{1} , \frac{1}{C} < P ( {c}_{1} \vert {x}_{k} ) then ∃ {c}_{2} , \frac{1}{C} > P ( {c}_{2} \vert {x}_{k} ) & ( 13 )\end{matrix}$$

In this case, equation (14) holds for the classification of the data xᵢ.

$$\begin{matrix}[ Equation 14 ] & \\ \frac{1}{C} < {max}_{c} P ( c \vert {x}_{i} ) & ( 14 )\end{matrix}$$

From equation (12) and equation (14), equation (11) is expressed as shown above.

From equation (11), equation (15) holds for D pieces of data {xᵢ}ᵢ₌₁^{D}.

$$\begin{matrix}[ Equation 15 ] & \\ {\sum }_{i = 1}^{D} {max}_{c} P ( c \vert {x}_{i} ) \geq {\sum }_{i = 1}^{D} \frac{1}{C} = \frac{D}{C} & ( 15 )\end{matrix}$$

From equation (10) and equation (15), equation (16) holds for the probability P(c|xᵢ) of classifying each of the D pieces of data xᵢ (where i is an integer such that 1≤i≤D) into one of the C classes.

$$\begin{matrix}[ Equation 16 ] & \\ \frac{1}{C} \leq \frac{1}{D} {\sum }_{i = 1}^{D} {max}_{c} P ( C \vert {x}_{i} ) \leq 1 & ( 16 )\end{matrix}$$

When learning with D pieces of data, if a value near the middle of equation (16) (the value of 1/DΣᵢ₌₁^{D} max_{c}P(c|xⁱ) is 1, only one of the sub-models (linear models of each linear combination node 121) is always selected. As a result, there is no non-linear interpolation between sub-models (linear models) for the D pieces of data. That is to say, for the D data points, the model generated by the piecewise linear network 20 becomes a complete piecewise linear function. Consequently, the linearity of the obtained model can be enhanced by adding, to an objective function such as equation (17) described below used during training, that a value near the middle side of equation (16) approaches 1 (increases).

### (Machine Learning in Piecewise Linear Network)

As the machine learning algorithm of the piecewise linear network 20, a back propagation algorithm typically used in machine learning of neural networks can be used. A back propagation method enables machine learning of coefficients (weightings w_{j,i} and bias values bᵢ) to be performed for both the linear combination nodes 121 and the selection nodes 131.

Here, the piecewise linear network 20 may perform machine learning so that the slope of the rise or fall of the activation function becomes steep. For example, in the example of FIG. 3, as a result of the fall of the line L121 and the rise of the line L122 becoming steeper, the proportion of the entire range (domain) of input values in which either of the linear models is dominant (regions A11 and A13 in the example of FIG. 3) becomes larger, and it is expected that the interpretation of the model will become easier.

In order to make the rise or fall of the activation function steep, the information processing device 10 may perform machine learning of the piecewise linear network 20 so that an objective function value L is minimized using equation (17) as the objective function.

$$\begin{matrix}[ Equation 17 ] & \\ ℒ = \frac{1}{D} {\sum }_{i = 1}^{D} {( f ( {x}_{i} ) - {y}_{i} )}^{2} - λ ( \frac{1}{D} {\sum }_{i = 1}^{D} {max}_{c} {σ}_{c} ( W {x}_{i} + b ) ) & ( 17 )\end{matrix}$$

In equation (17), “D” represents the number of pieces of data (xᵢ, yᵢ). “f(xᵢ)” represents the values of the linear combination nodes 121. “σ_{c}” corresponds to “σᵢ” in equation (2), and represents the values of the selection nodes 131. “c” represents the number of classes subject to classification (that is to say, the number of sub-models equals the number of elements in the selection node vector 130). “W” and “b” respectively represent a weighting coefficient value and a bias value used in the linear combination calculation of the selection nodes 131.

The first term “1/DΣᵢ₌₁^{D}(f(xᵢ)−yᵢ)²” on the right side is an error minimization term in the inverse error propagation method.

The second term “−λ(1/DΣᵢ₌₁^{D} max_{c}σ_{c}(Wxᵢ+b)” on the right side is a term for making the slope of the rise or fall of the activation function steep. “X” is a coefficient for adjusting the relative weighting of the first term and the second term. The larger the maximum value among the values of the elements (selection nodes 131) of the selection node vector 130, the larger the absolute value of the second term on the right side, and “−” causes the value of the second term on the right side to decrease. When the second term on the right side decreases, the objective function value L decreases. That is to say, the evaluation in the machine learning increases.

### (Modification of Piecewise Linear Network)

The piecewise linear network provided in the information processing device 10 may be configured by a variable number of hidden layer nodes.

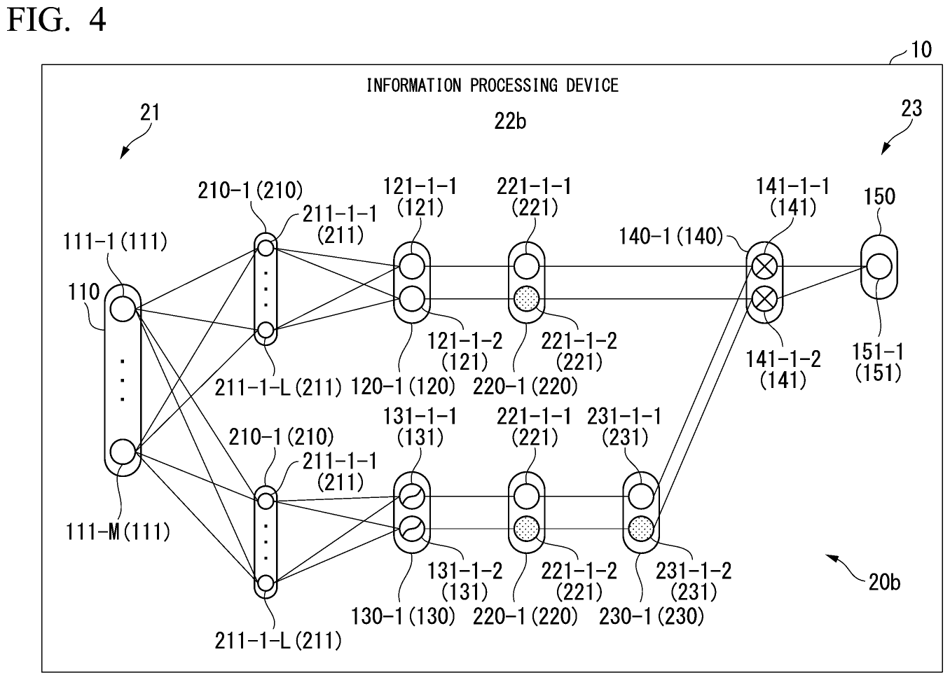

FIG. 4 is a diagram showing an example of a piecewise linear network in which the number of hidden layer nodes is variable. In the example of FIG. 4, the information processing device 10 includes the piecewise linear network 20b instead of the piecewise linear network 20 shown in FIG. 2.

In the configuration shown in FIG. 4, the piecewise linear network 20b includes an input layer 21, an intermediate layer (hidden layer) 22, and an output layer 23.

The input layer 21 is the same as in the case of the piecewise linear network 20 (FIG. 2). In the piecewise linear network 20b, the input node vector 110, the input nodes 111-1 to 111-M, and the input nodes 111 are referred to in the same manner as in the case of the piecewise linear network 20. The intermediate layer 22b includes batch normalization node vectors 210-1, a linear combination node vector 120-1, a selection node vector 130-1, binary mask node vectors 220-1, and a probabilization node vector 230-1.

In the example of FIG. 4, the intermediate layer 22b is shown with a configuration for one model. However, the piecewise linear network 20b is not limited to having the components for one model. Therefore, in FIG. 4, the components are referred to using the same reference symbols as in FIG. 2.

One or more batch normalization node vectors are collectively referred to as batch normalization node vectors 210. One or more linear combination node vectors are collectively referred to as linear combination node vectors 120. One or more selection node vectors are collectively referred to as selection node vectors 130. One or more binary mask node vectors are collectively referred to as binary mask node vectors 220. One or more probabilization node vectors are collectively referred to as probabilization node vectors 230. One or more element unit product node vectors are collectively referred to as element unit product node vectors 140.

The same batch normalization node vector 210 and the same binary mask node vector 220 are used on the linear combination node vector 120 side (the upper row in the example of FIG. 4) and the selection node vector 130 side (the lower row in the example of FIG. 4). Therefore, the same reference symbols are used in the example of FIG. 4.

The function of the linear combination node vector 120 is the same as in the case of the piecewise linear network 20. In the piecewise linear network 20b, the linear combination nodes 121-1-1 and 121-1-2 and the linear combination nodes 121 are referred to in the same manner as in the case of the piecewise linear network 20. The aspect that the number of elements in the linear combination node vector 120 is not limited to a specific number is also the same as in the case of the piecewise linear network 20.

Similarly, the function of the selection node vector 130 is the same as in the case of the piecewise linear network 20. In the piecewise linear network 20b, the selection nodes 131-1-1 and 131-1-2 and the selection nodes 131 are referred to in the same manner as in the case of the piecewise linear network 20. The aspect that the number of elements in the selection node vector 130 is not limited to a specific number is also the same as in the case of the piecewise linear network 20.

Similarly, the function of the element unit product node vector 140 is the same as in the case of the piecewise linear network 20. Also, in the piecewise linear network 20b, the element unit product nodes 141-1-1 and 141-1-2, and the element unit product nodes 141 are referred to in the same manner as in the case of the piecewise linear network 20. The aspect that the number of elements in the element unit product node vector 140 is not limited to a specific number is also the same as in the case of the piecewise linear network 20.

The batch normalization node vectors 210, the binary mask node vectors 220, and the probabilization node vector 230 are provided so that the number of combinations of linear combination nodes 121, selection nodes 131, and element unit product nodes 141 that are used can be made variable.

When the number of elements in the batch normalization node vector 210-1 is L (where L is a positive integer), the elements of the batch normalization node vector 210 are referred to as batch normalization nodes 211-1-1 to 211-1-L. However, the number of elements in the batch normalization node vector 210 is not limited to a specific number.

The batch normalization nodes 211-1-1 to 211-1-L are collectively referred to as batch normalization nodes 211.

The batch normalization node vectors 210 normalize the values of the input node vector 110. As a result of preparing the batch normalization nodes 211 according to different numbers of used sub-models, and appropriately using the nodes for the number of used sub-models, the values of the input node vector 110 are normalized according to different numbers of used sub-models. In the case of the example of FIG. 4, batch normalization node vectors 210 are prepared which include a batch normalization node vector for when only a single sub-model is used, and a batch normalization node vector for when two sub-models are used.

As a result of normalizing the values of the input node vector 110 according to different numbers of used sub-models, then even when some combinations of linear combination nodes 121, selection nodes 131, and element unit product nodes 141 are not used (that is to say, when the number of combinations of linear combination nodes 121, selection nodes 131, and element unit product nodes 141 that are used is reduced), the piecewise linear network 20b is capable of performing processing in both the machine learning phase (learning) and the operation phase (testing) without a significant reduction in accuracy.

In the example of FIG. 4, the number of elements in the binary mask node vectors 220-1 is two. Further, the elements of the binary mask node vectors 220 are referred to as binary mask nodes 221-1-1 and 221-1-2.

The binary mask nodes 221 of the binary mask node vector 220 located after the linear combination node vector 120 (downstream side in terms of data flow) are associated one-to-one with the linear combination nodes 121. Therefore, the number of elements in the binary mask node vector 220 is the same as the number of elements in the linear combination node vector 120.

The binary mask nodes 221 of the binary mask node vector 220 located after the selection node vector 130 (downstream side in terms of data flow) are associated one-to-one with the selection nodes 131. Therefore, the number of elements in the binary mask node vector 220 is the same as the number of elements in the selection node vector 130.

Each of the binary mask nodes 221 takes a scalar value of “1” or “0”. The binary mask nodes 221 operate as a mask by multiplying the input value (the value of the linear combination node 121 or the value of the selection node 131) by the value of the binary mask node 221 itself. When the value of the binary mask node 221 is “1”, the input value is output as is. On the other hand, when the value of the binary mask node 221 is “0”, 0 is output regardless of the input value.

The binary mask node vector 220 on the linear combination node vector 120 side and the binary mask node vector 220 on the selection node vector 130 side take the same values. As a result, the binary mask node vector 220 selects whether or not to mask each pair of linear combination nodes 121 and selection nodes 131 that are associated one-to-one with each other.

The probabilization node vector 230 is provided to set the total output value from the binary mask node vectors 220 to 1. As described above, the total output value from the selection node vector 130 is 1. In contrast, as a result of the binary mask node vectors 220 masking some of the elements of the selection node vector 130, the total output value from the binary mask node vectors 220 can be less than 1. Therefore, the probabilization node vector 230 performs adjustment so that the total output value from the binary mask node vectors 220 is 1. For example, the probabilization node vector 230 sets the total value of the element values to 1 by dividing each element value of the binary mask node vectors 220 by the total of the element values.

A slimmable neural network, which is a known technique, can be applied to the processing performed by the batch normalization node vectors 210 and the processing performed by the binary mask node vectors 220.

On the other hand, the configuration in which the same batch normalization node vector 210 is provided before the selection node vector 130 (upstream side in terms of data flow) as the batch normalization node vector 210 provided before the linear combination node vector 120, and in which both vectors have the same values, is a configuration which is unique to the piecewise linear network 20b according to the example embodiment.

The configuration in which the same binary mask node vector 220 is provided after the selection node vector 130 as the binary mask node vector 220 after the linear combination node vector 120, and in which both vectors have the same values, is also a configuration which is unique to the piecewise linear network 20b according to the example embodiment.

The configuration in which the probabilization node vector 230 is provided in addition to the binary mask node vector 220 after the selection node vector 130 is also a configuration which is unique to the piecewise linear network 20b according to the example embodiment.

With such a configuration, the slimmable neural network technique can be applied to the piecewise linear network 20b according to the example embodiment. As described above, processing can be performed in both the machine learning phase and the operation phase without a significant reduction in accuracy.

The output layer 23 of the piecewise linear network 20b is the same as in the case of the piecewise linear network 20 (FIG. 2). In the piecewise linear network 20b, the output node vector 150, the output node 151-1, and the output nodes 151 are referred to in the same manner as in the case of the piecewise linear network 20.

Although FIG. 4 only illustrates a single output node 151 (output node 151-1), like the case of the piecewise linear network 20 (FIG. 2), the number of output nodes 151 is not limited to a specific number. The number of output nodes 151 is the same as the number of element unit product node vectors 140.

As described above, in the piecewise linear network 20b, the number of combinations of linear combination nodes 121, selection nodes 131, and element unit product nodes 141 that are used can be made variable. For example, the piecewise linear network 20b learns from a set of learning datasets with combinations that include various numbers of linear combination nodes 121, selection nodes 131, and element unit product nodes 141. As a result, it is possible to reduce the processing load by reducing the number of used nodes as much as possible without lowering the processing accuracy, and it is possible to detect the optimum number of nodes. For example, the piecewise linear network 20b may set the number of combinations of selection nodes 131 and element unit product nodes 141 to a minimum number among the number or combinations that can ensure a correct answer rate greater than or equal to a predetermined threshold value.

### (Application of Piecewise Linear Network to Reinforcement Learning)

The piecewise linear network 20 or the piecewise linear network 20b can be applied to reinforcement learning. Reinforcement learning is a method that creates a policy that outputs an operation sequence (time series of operations) for a control target to reach a desired state from a start state, by using an observed value at each time point as an input. In reinforcement learning, a policy is formulated based on a reward calculated by a given method based on at least some states of the control target. In reinforcement learning, a policy is created which has the highest cumulative reward for the states that are reached to the desired state. For this reason, in reinforcement learning, prediction processing and the like is executed, which predicts the states that could be reached when a certain operation is performed with respect to a control target in a certain state, and predicts the rewards of those states. For example, the piecewise linear network 20 or the piecewise linear network 20b is used for prediction processing or in a function representing a policy.

A control device (for example, the information processing device 10) determines the operations to be performed with respect to the control target according to the policy created by using the piecewise linear network 20 or the piecewise linear network 20b, and controls the control target according to the determined operations. As a result of controlling the control target according to the policy, the control target is capable of achieving the desired state.

In this case, data from the surrounding environment, such as sensor data, is input to the piecewise linear network 20 or the piecewise linear network 20b. The output data obtained by applying the input data to a model is information that numerically represents the estimated state, or information that represents the reward of the estimated state. Furthermore, the information processing device 10 performs machine learning using an evaluation function that evaluates the state of the surrounding environment (for example, an evaluation function that calculates the reward mentioned above). As the evaluation function, for example, the equation (17) above can be used.

For example, when the information processing device 10 is applied to a game, the values of various parameters of the game are input to the piecewise linear network 20 or the piecewise linear network 20b as input data. The piecewise linear network 20 or the piecewise linear network 20b applies the input data to a model to calculate an operation amount such as an operation direction and angle of a joystick. In addition, the information processing device 10 performs machine learning of the piecewise linear network 20 or the piecewise linear network 20b using an evaluation function corresponding to a strategy for the game.

Furthermore, the information processing device 10 may be used for the operation control of a chemical plant.

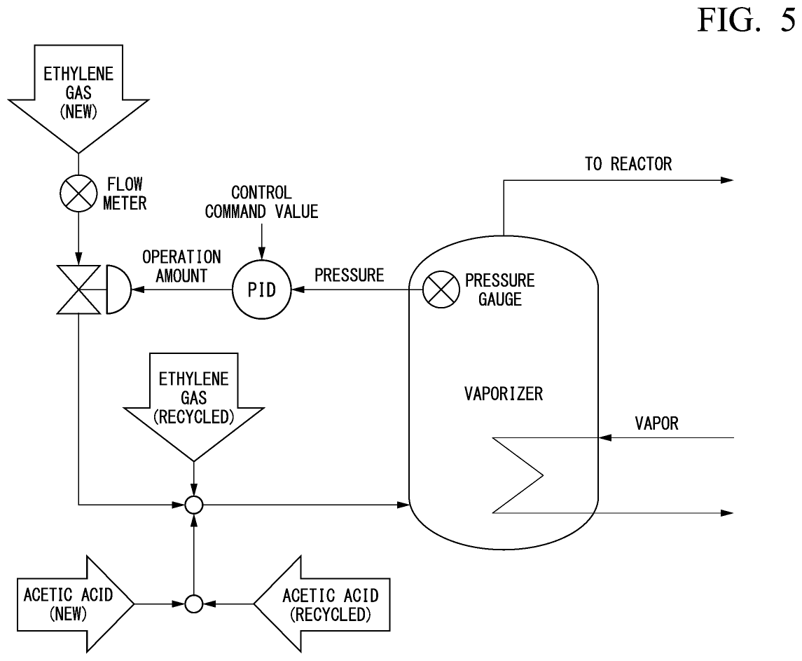

FIG. 5 is a diagram showing an example of a chemical plant.

In the example of FIG. 5, ethylene gas and liquid acetic acid are input to the chemical plant as raw materials. FIG. 5 shows the plant configuration of a process in which the input raw materials are heated by a vaporizer to vaporize the acetic acid, and then output to a reactor.

The information processing device 10 is used for PID control (Proportional-Integral-Differential Controller) of the operation amount of a valve (flow rate adjustment valve) that adjusts the flow rate of ethylene gas. The information processing device 10 determines the operation amount of the valve (flow rate adjustment valve) according to a policy created by using the piecewise linear network 20 or the piecewise linear network 20b. A control device that controls the valve controls the open/closed state of the valve according to the operation amount determined by the information processing device 10. In other words, the information processing device 10 receives data from sensors, such as a pressure gauge and a flow meter, and a control command value as inputs. Then, it applies the input data to a model and calculates an operation amount for executing the control command value.

In a simulator that simulates the operation of the chemical plant shown in FIG. 5, a simulation was executed of a task that controls a valve so that the pressure of the gas output to the reactor is held constant when a sudden change occurs in the pressure of the supplied ethylene gas, and a result was obtained in which reinforcement learning using the piecewise linear network 20 was faster than the case of a simple PID control, and the pressure of the output gas to the reactor could be restored in about three minutes.

In the above example, the control target is a single valve. However, the control target is not limited to this. A plurality of valves or all of the valves in a chemical plant may serve as control targets. Furthermore, the control target is not limited to a chemical plant. For example, it may be a construction site, an automobile production plant, a precision parts manufacturing plant, control of a robot, or the like. Moreover, a control device may include the information processing device 10. In other words, in this case, the control device determines the operations to be performed with respect to the control target according to a policy created by using the piecewise linear network 20 or the piecewise linear network 20b, and executes the determined operations with respect to the control target. As a result, the control device is capable of controlling the control target so that the control target is in a desired state.

Application of the piecewise linear network 20 or 20b to reinforcement learning enhances the training stability compared to application of a typical neural network to reinforcement learning.

Here, in reinforcement learning, and especially in reinforcement learning using function approximation such as deep learning, by using both of the reward obtained by carrying out the operations output by the policy of the own device which is performs the reinforcement learning, and the state values (functions) predicted by the device itself, the learning is progressed by feed backing them to its own policy and the predicted state values. In typical reinforcement learning, the training stability may be poor due to oscillations in policy function values during training due to a learning structure that uses feedback (feedback loop). This is thought to be a phenomenon that occurs due to the adoption of a complex model with excessive non-linearity.

On the other hand, by applying the piecewise linear network 20 or 20b to reinforcement learning, the non-linearity (complexity) can be adjusted, and the effect of increasing the training stability can be obtained.

In a comparative experiment between a case where the policy function is configured by the piecewise linear network 20, and a case where the policy function is configured by a typical neural network, it was confirmed that the training stability is improved in the configuration using the piecewise linear network 20.

As described above, each of the plurality of linear combination nodes 121 linearly combine input values (values of the input node vector 110). The selection nodes 131 are provided with respect to each linear combination node 121, and calculate, according to the input values, a value indicating whether or not a corresponding linear combination node 121 is selected. The output nodes 151 output an output value calculated based on the values of the linear combination nodes 121 and the values of the selection nodes 131.

As a result, in the piecewise linear network 20 or 20b, linear models formed by the linear combination nodes 121 are used as sub-models, and sub-models can be selected according to the input values. As a result, a piecewise linear model can be constructed, and a non-linear model can be (approximately) expressed.

In particular, in the piecewise linear network 20 or 20b, the complexity of the model can be controlled by adjusting the number of linear combination nodes 121, selection nodes 131, and element unit product nodes 141. As the number of linear combination nodes 121, selection nodes 131, and element unit product nodes 141 increases, the number of sub-models (linear models) that can be used in the piecewise linear network 20 or 20b increases. Therefore, more complicated piecewise linear models can be constructed.

Furthermore, the user is capable of knowing the piecewise linear network 20 or 20b has selected which sub-model (linear models) with which input value. Therefore, by analyzing the selected sub-models, the model can be interpreted (for example, a meaning can be attributed to the model). The user can interpret the model relatively easily in that the targets for interpretation are the individual linear models. That is to say, the interpretability of the model is relatively high.

Furthermore, the total value obtained by summing the values of the selection nodes 131 for all selection nodes 131 included in a single selection node vector 130 is a constant value (1). In addition, in the machine learning phase, the piecewise linear network 20 or 20b performs machine learning in which the maximum value of the values of the selection nodes 131 is made larger. For example, the piecewise linear network 20 or 20b performs machine learning in which the maximum value of the values of the selection nodes 131 is made larger by performing machine learning using equation (17) above.

As a result, the nodes constructed by the piecewise linear network 20 or 20b have a smaller non-linear interval (an interval in which the dominant linear model is not uniquely determined). Therefore, the interpretability of the model increases.

Further, the binary mask nodes 221 set, for each combination of linear combination nodes 121 and selection nodes 131, whether the combination is used or not used.

As a result, in the piecewise linear network 20b, the number of combinations of linear combination nodes 121 and selection nodes 131 that are used can be made variable.

For example, the piecewise linear network 20b learns from a set of learning datasets with combinations that include various numbers of linear combination nodes 121, selection nodes 131, and element unit product nodes 141. As a result, it is possible to reduce the processing load by reducing the number of used nodes as much as possible without lowering the processing accuracy, and it is possible to detect the optimum number of nodes.

### Configuration Example of Information Processing Device According to Example Embodiment

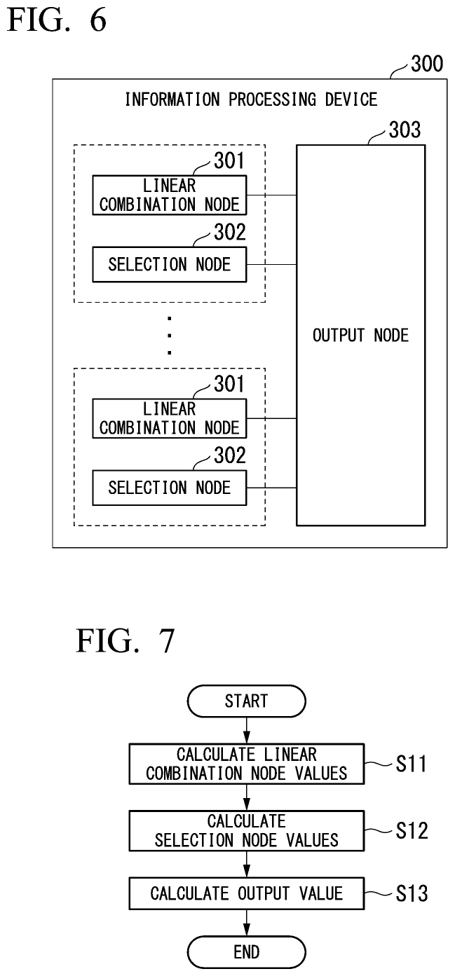

FIG. 6 is a diagram showing an example of a configuration of an information processing device according to the example embodiment. The information processing device 300 shown in FIG. 6 includes a plurality of linear combination nodes 301, selection nodes 302, and an output node 303.

Each of the plurality of linear combination nodes 301 linearly combine input values. The selection nodes 302 are provided with respect to each linear combination node 301, and calculate, according to the input values, a value indicating whether or not the corresponding linear combination node 301 is selected. The output node 303 outputs an output value calculated based on the values of the linear combination nodes 301 and the values of the selection nodes 302.

As a result, in the information processing device 300, linear models formed by the linear combination nodes 301 are used as sub-models, and sub-models can be selected according to the input values. As a result, a piecewise linear model can be constructed, and a non-linear model can be (approximately) expressed.

In particular, in the information processing device 300, the complexity of the model can be controlled by adjusting the number of linear combination nodes 301 and selection nodes 302. As the number of linear combination nodes 301 and selection nodes 302 increases, the number of sub-models (linear models) that can be used in the information processing device 300 increases. Therefore, more complicated piecewise linear models can be constructed.

Furthermore, the user is capable of knowing the information processing device 300 has selected which sub-model (linear models) with which input value. Therefore, by analyzing the selected sub-models, the model can be interpreted (for example, a meaning can be attributed to the model). The user can interpret the model relatively easily in that the targets for interpretation are the individual linear models. That is to say, the interpretability of the model is relatively high.

### Processing of Information Processing Method According to Example Embodiment

FIG. 7 is a diagram showing an example of the processing of an information processing method according to the example embodiment. In the example of FIG. 7, the information processing method includes; a step of calculating linear combination node values (step S11), a step of calculating selection nodes (step S12), and a step of calculating an output value (step S13).

In the step of calculating linear combination node values (step S11), a plurality of linear combination node values are calculated in which input values are linearly combined. In the step of calculating selection nodes (step S12), a selection node value that indicates whether or not the linear combination node value is selected is calculated for each linear combination node value. In the step of calculating an output value (step S13), an output value is calculated based on the linear combination node values and the selection node values.

In the information processing method, linear models that linearly combine input values are used as sub-models, and sub-models can be selected according to the input values. As a result, a piecewise linear model can be constructed, and a non-linear model can be (approximately) expressed.

In particular, in the information processing method, the complexity of the model can be controlled by adjusting the number of linear combination node values and selection node values. As the number of linear combination node values and selection node values increases, the number of sub-models (linear models) that can be used in the information processing method increases. Therefore, more complicated piecewise linear models can be constructed.

Furthermore, the user who uses the information processing method is capable of knowing which sub-model (linear models) has been selected with which input value Therefore, by analyzing the selected sub-models, the model can be interpreted (for example, a meaning can be attributed to the model). The user can interpret the model relatively easily in that the targets for interpretation are the individual linear models. That is to say, the interpretability of the model is relatively high.

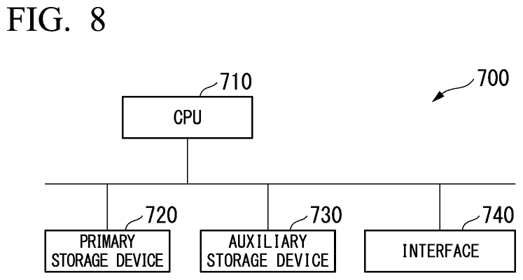

FIG. 8 is a schematic block diagram showing a configuration of a computer according to at least one example embodiment.

In the configuration shown in FIG. 8, the computer 700 includes a CPU (Central Processing Unit) 710, a primary storage device 720, an auxiliary storage device 730, and an interface 740. Any one or more of the information processing devices 10 and 300 described above may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Further, the CPU 710 secures a storage area corresponding to each of the storage units in the main storage device 720 according to the program. The communication of each device with other devices is executed as a result of the interface 740 having a communication function and performing communication according to the control of the CPU 710. The auxiliary storage device 730 is a non-transitory recording medium such as a CD (Compact Disc) or a DVD (digital versatile disc).

When the information processing device 10 is implemented by the computer 700, the operation of the control unit 19 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area corresponding to the storage unit 18 in the main storage device 720 according to the program. The communication performed by the communication unit 11 is executed as a result of the interface 740 having a communication function and performing communication according to the control of the CPU 710. The functions of the display unit 12 are executed as a result of the interface 740 having a display device, and images being displayed on the display screen of the display device according to the control of the CPU 710. The functions of the operation input unit 13 are performed as a result of the interface 740 having an input device, and accepting user inputs, and outputting signals indicating the accepted user inputs to the CPU 710.

The processing of the piecewise linear network 20 and each unit thereof is stored in the auxiliary storage device 730 in the form of a program. The CPU 710 reads the program from the auxiliary storage device 730, expands the program in the main storage device 720, and executes the processing described above according to the program. As a result, the processing is performed by the piecewise linear network 20 and each unit thereof.

The processing of the piecewise linear network 20b and each unit thereof is stored in the auxiliary storage device 730 in the form of a program. The CPU 710 reads the program from the auxiliary storage device 730, expands the program in the main storage device 720, and executes the processing described above according to the program. As a result, the processing is performed by the piecewise linear network 20b and each unit thereof.

When the information processing device 300 is implemented by the computer 700, the operation of the linear combination nodes 301, the selection nodes 302, and the output node 303 is stored in the auxiliary storage device 730 in the form of a program. The CPU 710 reads the program from the auxiliary storage device 730, expands the program in the main storage device 720, and executes the processing described above according to the program.

Furthermore, a program for executing some or all of the processing performed by the control unit 19 may be recorded in a computer-readable recording medium, and the processing of each unit may be performed by a computer system reading and executing the program recorded on the recording medium. The “computer system” referred to here includes an OS (Operating System) and hardware such as a peripheral device.

Furthermore, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into a computer system. Moreover, the program may be one capable of realizing some of the functions described above. Further, the functions described above may be realized in combination with a program already recorded in the computer system.

The present invention has been described above with reference to the example embodiments. However, the present invention is not limited to the example embodiments above. Various changes to the configuration and details of the present invention that can be understood by those skilled in the art can be made within the scope of the present invention.

This application is based upon and claims the benefit of priority from Japanese patent application No. 2019-064977, filed Mar. 28, 2019, the disclosure of which is incorporated herein in its entirety by reference.

### INDUSTRIAL APPLICABILITY

The present invention may be applied to an information processing device, an information processing method, and a recording medium.

### REFERENCE SYMBOLS

10, 300 Information processing device
11 Communication unit
12 Display unit
13 Operation input unit
18 Storage unit
19 Control unit
20, 20b Piecewise linear network
21 Input layer
22, 22b Intermediate layer
23 Output layer
110 Input node vector
111 Input node
120 Linear combination node vector
121, 301 Linear combination node
130 Selection node vector
131, 302 Selection node
140 Element unit product node vector
141 Element unit product node
150 Output node vector
151, 303 Output node
210 Batch normalization node vector
211 Batch normalization node
220 Binary mask node vector
221 Binary mask node
230 Probabilization node vector
231 Probabilization node

1. An information processing device comprising:
a plurality of linear combination nodes that linearly combine input values;
a selection node that is provided to the linear combination node and calculates, according to the input values, a value indicating whether or not a corresponding linear combination node is selected; and
an output node that outputs an output value calculated based on a value of the linear combination node and a value of the selection node.

2. The information processing device according to claim 1,
wherein a total value obtained by summing the value of the selection node for all selection nodes is a constant value, and
in a machine learning phase, machine learning is performed that increases a maximum value of the value of the selection node.

3. An information processing device according to claim 1 or 2, further comprising:
a binary mask node that sets whether a combination of the linear combination node and the selection node is used or not used.

4. An information processing method executed by a computer, comprising:
calculating a plurality of linear combination node values in which input values are linearly combined;
calculating, with respect to the linear combination node value, a selection node value indicating whether or not the linear combination node value is selected; and
calculating an output value based on the linear combination node value and the selection node value.

5. A non-transitory recording medium that stores a program that causes a computer to execute:
calculating a plurality of linear combination node values in which input values are linearly combined;
calculating, with respect to the linear combination node value, a selection node value indicating whether or not the linear combination node value is selected; and
calculating an output value based on the linear combination node value and the selection node value.
